(19) United States
(12) Patent Application Publication
(10) Pub. No.: US 2019/0373207 A1
(43) Pub. Date: Dec. 5, 2019

(54) VIDEO SAMPLING BAR SYSTEM AND METHOD

(71) Applicant: Mark Broxterman, Toronto (CA)

(72) Inventor: Mark Broxterman, Toronto (CA)

(21) Appl. No.: 15/994,286

(22) Filed: May 31, 2018

(51) Int. Cl. H04N 5/64; A47B 81/06; A47F 9/00; G06Q 30/02

(52) U.S. Cl. CPC H04N 5/64; G06Q 30/0241; A47F 9/00; A47B 81/06

(57) ABSTRACT

A video sampling bar is a mobile bar that features a video screen. The bar is completely wireless. A digital self-powered sampling unit that replaces traditional print advertising with built in digital display. The device is also enabled as functional furniture and may be used to promote items for consumer use or purchase.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of support racks and more specifically relates to a video sampling bar system for use.

### 2. Description of Related Art

Many individuals enjoy entertaining themselves and others in residential and commercial settings. Residential homes often do not have much by way of ambience for entertaining. Commercial establishments may have lighted signage, but these may become easily damaged or burn out after a short duration. The current signage is not multi-functional. A suitable solution is desired.

U.S. Pub. No. 2016/0086229 to Brian B. Walker relates to a digital advertisement display stand. The described digital advertisement display stand comprising a product display unit having multiple spaces for supporting, displaying, and advertising goods and services, at least one static display located on the product display unit, at least one live action monitor located on the product display unit with the live action monitor having a touch screen, a central processing unit located in the live action monitor, a memory storage unit connected to the central processing unit, and a long distance wireless data transmission device connected to the central processing unit and at least one offsite control center in wireless communication with the long distance wireless data transmission device of the live action monitor.

### BRIEF SUMMARY OF THE INVENTION

In view of the foregoing disadvantages inherent in the known support racks art, the present disclosure provides a novel video sampling bar system and method. The general purpose of the present disclosure, which will be described subsequently in greater detail, is to provide a mobile bar that features a video screen; the bar is 100% wireless and a digital self-powered sampling unit that replaces traditional print advertising with built in digital display. The device also serves as functional furniture suitable for use in entertaining and storing items.

A video sampling bar is disclosed herein. The video sampling bar includes a mobile bar assembly including an enclosure having a bar-counter-top; a frame; and an outer-shell; a video screen; a powerer; and powering ports; wherein the mobile bar assembly comprises the enclosure for housing the video screen, the powerer, and the powering ports. The enclosure is defined by the bar-counter-top and the outer-shell, and the frame. The video screen, the powering ports are powered via the powerer; wherein the video sampling bar is configured for displaying at least one video image and promoting and displaying an item for consumption.

A method of using a video sampling bar system is also disclosed herein. The method of using the video sampling bar may comprise the steps of: providing the video sampling bar comprising a mobile bar assembly including an enclosure having a bar-counter-top; a frame; and an outer-shell; a video screen; a powerer; and powering ports; displaying at least one video image; and displaying an item for consumption. The method may further comprise the step of promoting the item for consumption via the at least one video image. The device may be recharged via appropriate means for further remote use.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a video sampling bar system and method, constructed and operative according to the teachings of the present disclosure.

FIG. 1 is a front perspective view of the video sampling bar during an ‘in-use’ condition, according to an embodiment of the disclosure.

FIG. 2 is a front perspective view of the video sampling bar of FIG. 1, according to an embodiment of the present disclosure.

FIG. 3 is a front perspective view of the video sampling bar of FIG. 1, according to an embodiment of the present disclosure.

FIG. 4 is a front perspective view of the video sampling bar of FIG. 1, according to an embodiment of the present disclosure.

FIG. 5 is a flow diagram illustrating a method of use for the video sampling bar, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to support racks and more particularly to a video sampling bar system and method as used to improve the efficiency of entertaining and functional use of furniture for promoting products.

Generally, the present invention serves as a means to effectively eliminate the cost of print signage with a fully versatile digital screen offered in a functional furniture piece. As designed it offers the capability to play video in addition to static ad content. It virtually eliminates the need to upkeep battered and worn consumer facing print advertising. The self-sufficient power source provides over 8 hours of screen life. The screen is preferably 55 inches and has easy to use Chromecast synchronization or the like. Further, it has capability to power other appliances such as blenders, skillets, toaster ovens, microwaves, and electronics for up to 8 hours. Since it is remotely powered the device can be stationed anywhere in a dwelling, store, establishment or the like; not just against walls and near power outlets. The modular construction may comprise retractable shelving units for point of sale product merchandising. It is sleek, durable, with a high-quality bar preferably with polished wood and Corian countertop, or the like. As designed it is relatively easy to transport throughout the room it is in and beyond, as desired.

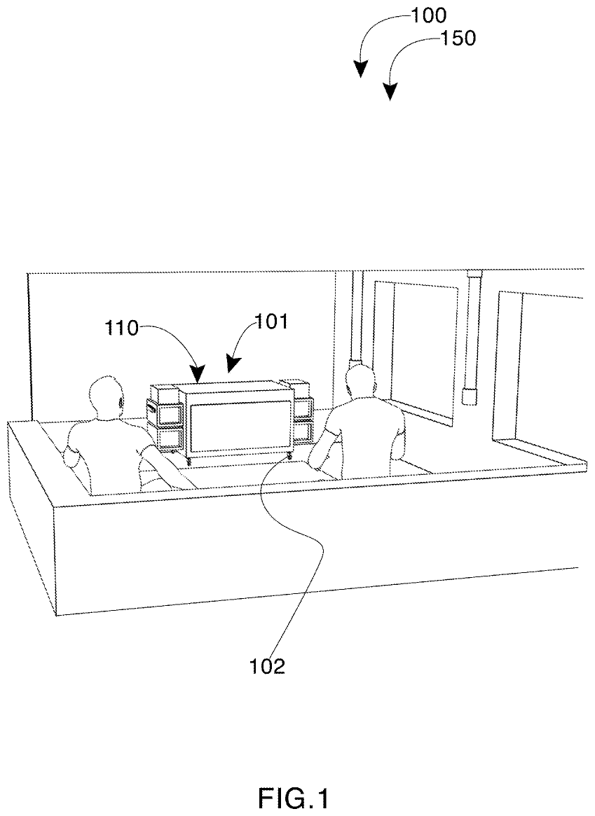

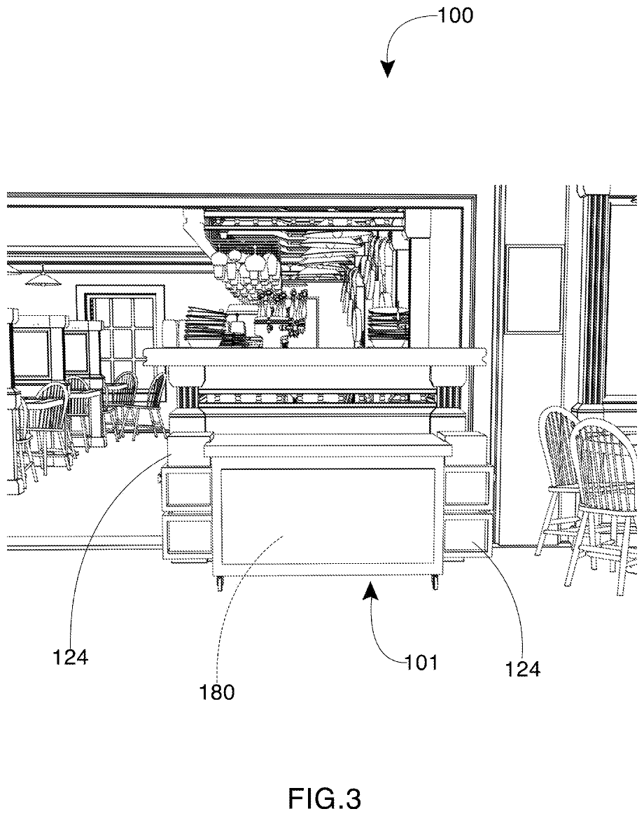

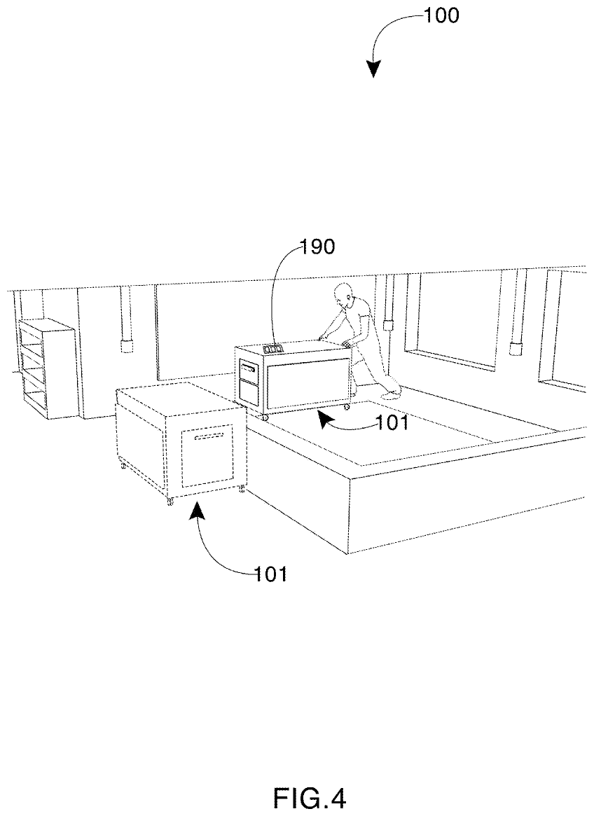

Referring now more specifically to the drawings by numerals of reference, there is shown in FIGS. 1-5, various views of a video sampling bar 100. FIG. 1 shows a video sampling bar 100 during an ‘in-use’ condition 150, according to an embodiment of the present disclosure. As Illustrated, the video sampling bar 100 may be as a video sampling bar assembly 101 including an enclosure 110 having a bar-counter-top 120; a frame 130; and an outer-shell 160; a video screen 170; a powered 180; and powering ports 190; wherein the mobile bar assembly 101 comprises the enclosure 110 for housing the video screen 170, the powered 180, and the powering ports 190. The enclosure 110 is defined by the bar-counter-top 120, the outer-shell 160, and the frame 130. The video screen 170, the powering ports 190 are powered via the powered 180; wherein the video sampling bar 100 is configured for displaying at least one video image 172 (as shown) and promoting and displaying at least one item for consumption 124. The at least one item for consumption 124 may comprise for example a particular kind of beer or wine or the like, as shown. The video sampling bar 100 is wireless and fully capable of receiving data from the internet or other such source. The video sampling bar 100 further comprises a microchip and WIFI capability. Those with ordinary skill in the art will now appreciate that upon reading this specification and by their understanding the art of wireless communication and necessary components as described herein, methods of such communication will be understood by those knowledgeable in such art. The video sampling bar 100 may further comprise wheels 102 such that it is readily moveable between locations. In this way the present invention is remotely portable and doesn't require positioning next to outlets or the like.

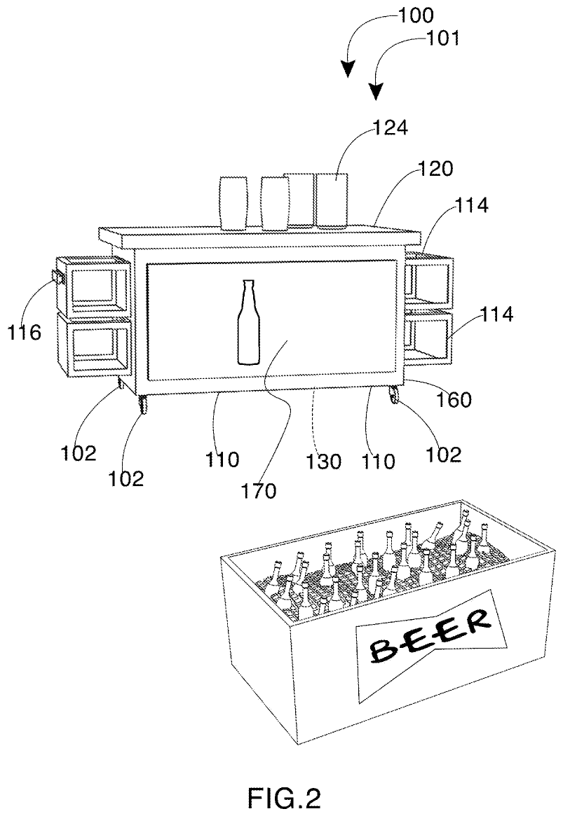

FIGS. 2-4 show various perspective views of the video sampling bar 100 of FIG. 1, according to an embodiment of the present disclosure. As above, the video sampling bar 100 may include retractable shelving units 112; wherein the retractable shelving units 112 preferably run parallel to the video screen 170. The retractable shelving units 112 may comprise display-apertures 114 parallel to video screen and the retractable shelving units 112 comprise handles 116 such that the retractable shelving units 112 can be easily opened and closed.

Referring now to the video screen 170; video screen 170 displays a static-image or a non-static-image, as desired. The static image may comprise an advertisement or the like. In this way the present invention is useful for and configured to promote products via video (video image 172).

In certain embodiments the video sampling bar 100 is modular such that components such as retractable shelving units 112 can be inter-changed at will for suitable storage and display purposes for example display-apertures 114 may have apertures alternately placed for different locational displayment means. Referring now to powering ports 190; powering ports 190 may comprise USB-ports and/or AC-receptacles. Other ports may be included for powering appliances, and devices as desired. The powerer 180 has capability to power other appliances such as blenders, skillets, toaster ovens, microwaves, and electronics for up to 8 hours.

The powerer 180 comprises a DC battery in preferred embodiments; wherein the DC battery is rechargeable. As designed the DC battery is able to provide sufficient power to the video screen and/or plugged in appliances and devices for at least 8 hours of use.

According to one embodiment, the video sampling bar 100 may be arranged as a kit. The kit may include video sampling bar assembly 101, retractable shelving units 112, different bar-counter-top 120. The instructions may detail functional modular relationships in relation to the structure of the video sampling bar 100 (such that the video sampling bar 100 can be used, maintained, or the like, in a preferred manner).

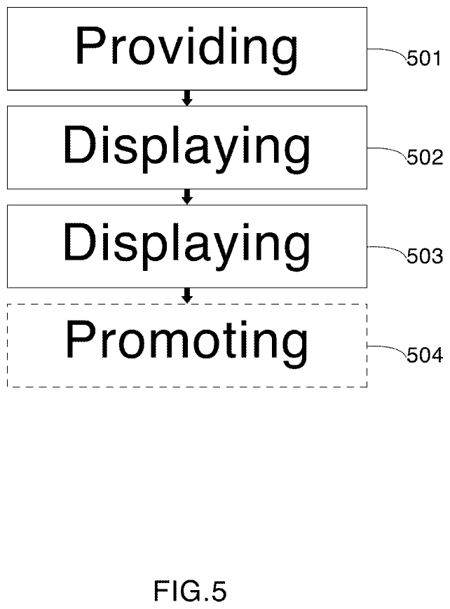

FIG. 5 is a flow diagram 550 illustrating a method of use 500, according to an embodiment of the present disclosure. As illustrated, the method of use 500 for the video sampling bar 100 may include the steps of: 501 providing the video sampling bar comprising a mobile bar assembly including an enclosure having a bar-counter-top; a frame; and an outer-shell; a video screen; a powerer; and powering ports; 502 displaying at least one video image; and 503 displaying an item for consumption. The method may further comprise the step of 504 promoting the item for consumption via the at least one video image.

It should be noted that step 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for video sampling bar 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A video sampling bar, the video sampling bar comprising:
a mobile bar assembly including,
an enclosure having,
a bar-counter-top;
a frame; and
an outer-shell;
a video screen;
a powerer; and
powering ports; and
wherein said mobile bar assembly comprises said enclosure for housing said video screen, said powerer, and said powering ports;
wherein said enclosure is defined by said bar-counter-top and said outer-shell, and said frame;
wherein said video screen, said powering ports are powered via said powerer; and
wherein said video sampling bar is configured for displaying at least one video image and promoting and displaying an item for consumption.

2. The video sampling bar of claim 1, further comprising retractable shelving units.

3. The video sampling bar of claim 2, wherein said video sampling bar is wireless.

4. The video sampling bar of claim 3, wherein said video screen displays a static-image.

5. The video sampling bar of claim 3, wherein said video screen displays a non-static-image.

6. The video sampling bar of claim 4, wherein the static image is an advertisement.

7. The video sampling bar of claim 3, further comprising wheels.

8. The video sampling bar of claim 7, wherein the video sampling bar is modular.

9. The video sampling bar of claim 1, wherein the powering ports comprise USB-ports.

10. The video sampling bar of claim 1, wherein the powering ports comprise AC-receptacles.

11. The video sampling bar of claim 1, wherein the powerer comprises a DC battery.

12. The video sampling bar of claim 11, wherein the DC battery is rechargeable.

13. The video sampling bar of claim 12, wherein the DC battery is able to provide sufficient power to said video screen for at least 8 hours of use.

14. The video sampling bar of claim 2, wherein the retractable shelving units run parallel to said video screen.

15. The video sampling bar of claim 14, wherein the retractable shelving units comprise display-apertures parallel to said video screen and the retractable shelving units comprise handles.

16. The video sampling bar of claim 1, further comprising a microchip and WIFI capability.

17. A video sampling bar, the video sampling bar comprising:
a mobile bar assembly including,
an enclosure having,
a bar-counter-top;
a frame; and
an outer-shell;
a video screen;
a powerer;
powering ports;
a microchip and WIFI capability;
wheels; and
retractable shelving units; and
wherein said mobile bar assembly comprises said enclosure for housing said video screen, said powerer, and said powering ports;
wherein said enclosure is defined by said bar-counter-top and said outer-shell, and said frame;
wherein said video sampling bar is wireless;
wherein said video screen displays a static-image and alternately a non-static-image;
wherein said video screen, said powering ports are powered via said powerer;
wherein the video sampling bar is modular;
wherein the powering ports comprise USB-ports and AC-receptacles;
wherein the powerer comprises a DC battery;
wherein the DC battery is rechargeable;
wherein the DC battery is able to provide sufficient power to said video screen for at least 8 hours of use;
wherein the retractable shelving units run parallel to said video screen;
wherein the retractable shelving units comprise display-apertures parallel to said video screen and the retractable shelving units comprise handles; and
wherein said video sampling bar is configured for displaying at least one video image and promoting and displaying an item for consumption.

18. The video sampling bar of claim 17, further comprising set of instructions; and
wherein the video sampling bar is arranged as a kit.

19. A method of use for the video sampling bar, the method comprising the steps of:
providing the video sampling bar comprising a mobile bar assembly including,
an enclosure having,
a bar-counter-top;
a frame; and
an outer-shell;
a video screen;
a powerer; and
powering ports;
displaying at least one video image; and
displaying an item for consumption.

20. The method of claim 19, further comprising the step of:
promoting said item for consumption via said at least one video image.
